(19) United States
(12) Patent Application Publication
(10) Pub. No.: US 2018/0255317 A1
(43) Pub. Date: Sep. 6, 2018

(54) METHOD FOR RECONSTRUCTING VIDEO STREAM

(71) Applicant: MStar Semiconductor, Inc., ChuPei (TW)

(72) Inventor: Sung-Wen WANG, Hsinchu Hsien (TW)

(21) Appl. No.: 15/889,552

(22) Filed: Feb. 6, 2018

(30) Foreign Application Priority Data
Mar. 1, 2017 (TW) 106106585

(51) Int. Cl. H04N 19/55; H04N 19/119; H04N 19/167; H04N 19/174

(52) U.S. Cl. CPC H04N 19/55; H04N 19/174; H04N 19/167; H04N 19/119

(57) ABSTRACT

A video stream to be reconstructed includes encoded data of multiple images encoded according to the High Efficiency Video Coding (HEVC) standard. Each of the images includes multiple tiles, and the encoded data of each image includes multiple data slices and multiple parameter sets. A method for reconstructing the video stream includes receiving the video stream that is to be reconstructed, analyzing the parameter sets in the video stream, retrieving multiple sets of interested video data corresponding to a region of interest of each image from the data slices according to the parameter sets, updating the parameter sets to multiple updated parameter sets, and generating a reconstructed image stream according to the interested video data and the updated parameter sets. The tiles of each image belong to a motion-constrained tile set defined in the HEVC standard.

This application claims the benefit of Taiwan application Serial No. 106106585, filed Mar. 1, 2017, the subject matter of which is incorporated herein by reference.

### BACKGROUND OF THE INVENTION

### Field of the Invention

The invention relates in general to a method for reconstructing a video stream, and more particularly to a method for reconstructing a video stream encoded according to the High Efficiency Video Coding (HEVC) standard.

### Description of the Related Art

In response to the ever-increasing consumer demands on video quality, video producers are also evermore dedicated to producing higher quality video contents. A high-definition video usually includes a colossal amount of data, and so various video compression methods have been developed to better transmit and store video contents. For example, the High Efficiency Video Coding (HEVC) standard was published in January of 2013. In the HEVC standard, each image of a video may be divided into multiple tiles. For each region in each tile, a corresponding region in a temporally preceding image may be calculated according to a motion vector obtained during compression and encoding operations, and decompression may then be conducted according to data of the corresponding region in the preceding image. In the HEVC standard, if corresponding regions of all regions of one tile entirely fall within a range of a same tile of the preceding image, it means that this tile belongs to a motion-constrained tile set. That is to say, the prediction of images belonging to the motion-constrained tile set is confined as being conducted without referring to tiles other than the corresponding tile.

In order to in real time decompress and play compressed video contents, in the prior art, decompression is often carried out by different hardware devices designed particularly for different image compression methods and video content standards. However, also due to limitations of hardware equipments, it is frequent that hardware equipments in older versions cannot play new high-definition video contents. For example, a decompression unit in a display device that supports a 4K resolution cannot decompress video contents having an 8K resolution, which means that the video contents in the 8K resolution cannot be displayed. In other words, when incompatibility exists between image standards and hardware equipments, it is probable that video contents cannot be displayed, hence leading to application inconveniences.

### SUMMARY OF THE INVENTION

A method for reconstructing a video stream is provided according to an embodiment of the present invention. The video stream that is to be reconstructed includes encoded data of a plurality of images encoded according to the High Efficiency Video Coding (HEVC) standard. Each of the images includes a plurality of tiles, and the encoded data of each of the images includes a plurality of data slices and a plurality of parameter sets. The tiles of each of the images belong to a motion-constrained tile set (MCTS) defined in the HEVC standard.

The method for reconstructing a video stream includes receiving the video stream that is to be reconstructed, analyzing the parameter sets in the video stream, retrieving a plurality of sets of interested video data corresponding to a first region of interest of each of the images from the data slices according to the parameter sets, updating the parameter sets to a plurality of first updated parameter sets, and generating a reconstructed video stream according to the interested video data and the first updated parameter sets.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a video reconstruction system according to an embodiment of the present invention;

FIG. 2 is a schematic diagram of a plurality of images of a video stream that is to be reconstructed according to an embodiment of the present invention;

FIG. 3 is a flowchart of a method for reconstructing a video stream according to an embodiment of the present invention;

FIG. 4 is a detailed partial flowchart of the method in FIG. 3;

FIG. 5 is a detailed partial flowchart of the method in FIG. 3; and

FIG. 6 is a partial flowchart of the method in FIG. 3.

### DETAILED DESCRIPTION OF THE INVENTION

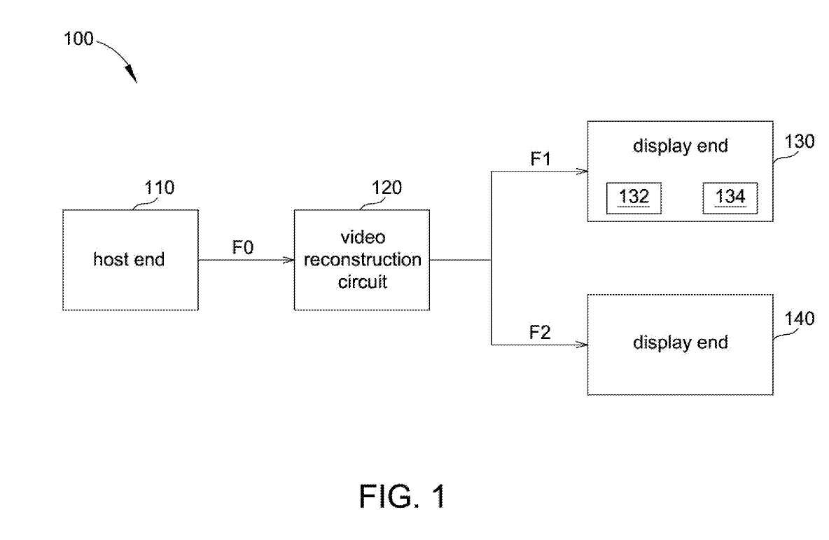

FIG. 1 shows a schematic diagram of a video reconstruction system 100 according to an embodiment of the present invention. The video reconstruction system 100 includes a host end 110, a video reconstruction circuit 120 and a display end 130. In some embodiments of the present invention, a video stream provided by the host end 110 may have an 8K resolution, and the display end 130 includes a display device 132 having a 4K resolution and a corresponding decompression circuit 134. Because the resolution of a video stream F0 exceeds the limit that the display end 130 is capable of processing, the decompression circuit 134 at the display end 130 cannot perform a corresponding decompression function when the display end 130 directly receives the video stream F0. However, the image reconstruction circuit 120 may reconstruct the video stream F0 into a video stream F1 having a lower resolution, e.g., a 4K resolution. Thus, the decompression circuit 134 at the display end 130 may decompress the video stream F1, and video contents of the video stream F1 may then be displayed on the display device 132.

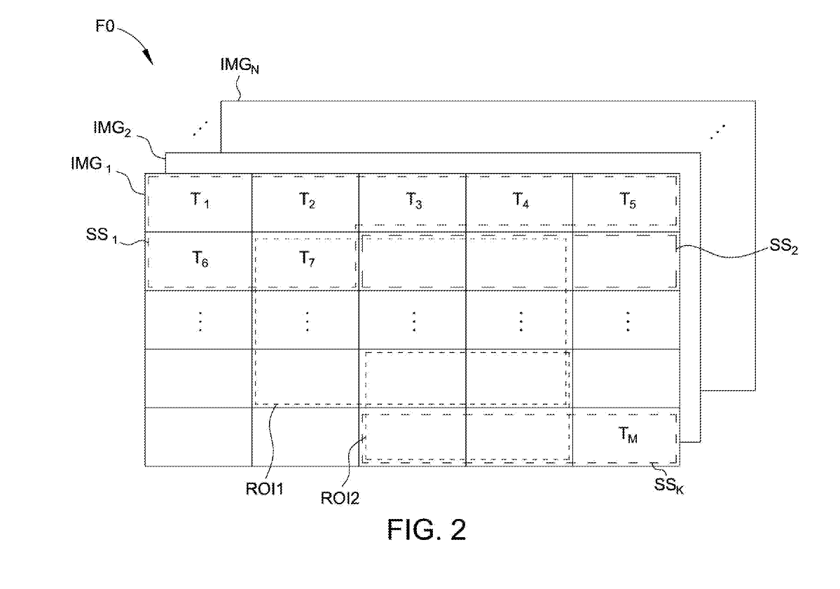

FIG. 2 shows a schematic diagram of a plurality of images IMG₁ to IMG_{N} of the video stream F0 that is to be reconstructed according to an embodiment of the present invention. The video stream F0 includes encoded data of the N images IMG₁ to IMG_{N} encoded according to the High Efficiency Video Coding (HEVC) standard, where N is a positive integer. Each of the images IMG₁ to IMG_{N} includes a plurality of tiles. For example, in FIG. 1, the image IMG1 is divided into M tiles T₁ to T_{M}, where M is a positive integer greater than 1. In an embodiment of the present invention, the tiles of all of the images IMG₁ to IMG_{N} belong to a motion-constrained tile set (MCTS) defined in the HEVC standard. That is to say, each of the tiles may be independently decoded without referring to contents of other tiles of the same image.

Further, according to the HEVC standard, the encoded data of each of the images IMG₁ to IMG_{N} includes a plurality of data slices associated with video contents and a plurality of parameter sets associated with the standard and compression method of the video. The data slices may include contents of partial regions of an image or even contents of an entire image. In FIG. 2, the image IMG₁ may include data slices SS₁ to SS_{K}, each of which corresponds to image contents of different regions in the image IMG₁. Further, sizes of the regions corresponding to the slices SS₁ to SS_{K} may also be different. In the HEVC standard, the data slices are encoded according to a variable length. Thus, based on contents of data slices alone, the corresponding relationship between each set of data and pixels in each of the regions in the image cannot be learned. In comparison, parameter sets are mostly encoded according to a fixed length, and are generally parameters for recording the standard and compression method of the video. For example, the parameter sets in the HEVC standard may include a video parameter set (VPS), a sequence parameter set (SPS), a picture parameter set (PPS) and supplemental enhance information (SEI).

Contents of a picture parameter set substantially include initial configuration parameters of tiles, e.g., information of how an image is divided into tiles, and the number and sizes of the tiles. The picture parameter set provides reference for different data slices. For example, a header of each data slice may record the picture parameter set the data slice uses, and data contents in the data slice may be analyzed according to the corresponding picture parameter set. Contents of a sequence parameter set are substantially associated with decoding, and may be parameters such as length and width, resolution, level and size of an image, and may be referred by different picture parameter sets. Contents of a video parameter set are substantially associated with syntax used, such as parameters of a profile level of the video and whether the video supports multi-view coding, and may be referred by different sequence parameter sets. Contents of supplementary enhance information record other extended supplemental information, such as information regarding MCTS.

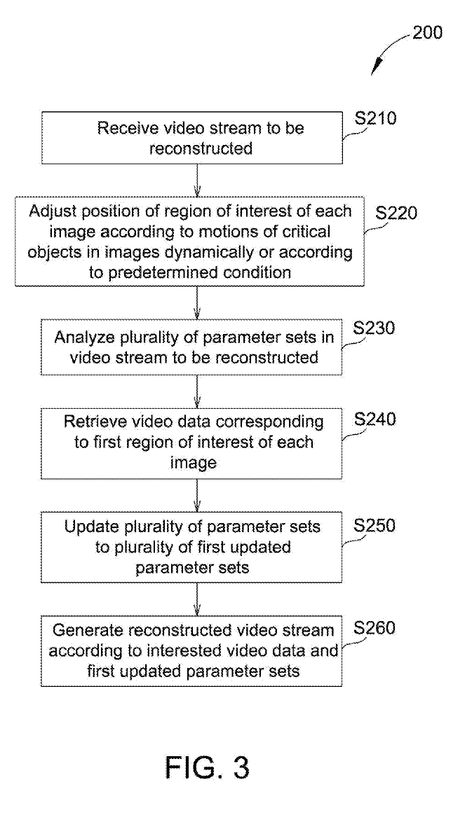

FIG. 3 shows a flowchart of a method 200 for reconstructing a video stream according to an embodiment of the present invention. The method 200 includes, for example but not limited to, step S210 to step S260 that are not limited to being performed in an order in FIG. 3. In some embodiments of the present invention, the image reconstruction circuit 120 may reconstruct the video stream F0 into the video stream F1 by performing the method 200.

In step S210, the video stream F0 that is to be reconstructed is received.

In step S220, a position of a region of interest of each of the images IMG_{1,} to IMG_{N} is adjusted according to motions of objects in the images IMG₁ to IMG_{N} dynamically or according to a predetermined condition.

In step S230, a plurality of parameter sets in the video stream F0 are analyzed.

In step S240, interested video data corresponding to a first region of interest ROI of each of the images IMG₁ to IMG_{N} is retrieved from the data slices SS₁ to SS_{K} according to the parameter sets.

In step S250, the parameter sets are updated to a plurality of first updated parameter sets.

In step S260, the reconstructed video stream F1 is generated according to the interested video data and the first updated parameter sets.

In step S210, the video reconstruction circuit 120 receives the video stream F0 that is to be reconstructed provided by the host end 110. Because the resolution of the video stream F0 is higher and cannot be displayed at the display end 130, the video reconstruction circuit 10 may delete a part of the contents of each of the images IMG₁ to IMG_{N} in the video stream F0 and preserves contents of user-required regions or contents of a region of interest in each of the images IMG₁ to IMG_{N}, i.e., contents of the regions of interest. For example, in FIG. 2, a user-required region or a region of interest is a central region of the image IMG₁. Thus, the central region of the image IMG₁ may be defined as the region of interest ROI1 of the image IMG₁. Further, the size of the region of interest ROI1 may be determined according to hardware specifications of the display end 130. For example, assume that the original image IMG₁ includes data of 7680×4320 pixels, and the display end 130 is capable of displaying video contents of only 3840×2160 pixels. In this case, the size of the region of interest ROI1 may be set to 3840×2160 pixels. Thus, it is ensured that the display end 130 can normally display video contents corresponding to the region of interest.

In some embodiments of the present invention, in step S220, the video reconstruction circuit 120 may, dynamically or according to a predetermined condition, adjust the position of the region of interest in each of the images IMG₁ to IMG_{N} according to motions of the critical objects in the images IMG₁ to IMG_{N}. For example, the video reconstruction circuit 120 may select the central region or other predetermined regions of each of the IMG₁ to IMG_{N} as a region of interest. Alternatively, the video reconstruction circuit 120 may reallocate a region of interest according to motions of user-concerned critical objects in the images IMG₁to IMG_{N}, such that the regions of interest in the images IMG₁ to IMG_{N} may include user-concerned objects.

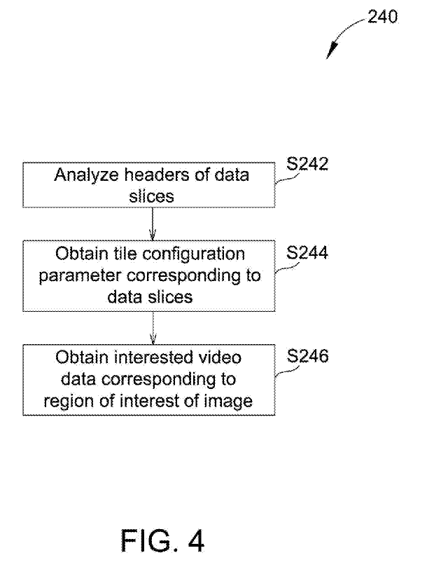

In step S230, the video reconstruction circuit 120 further analyzes the parameter sets in the video stream F0 that is to be reconstructed, including the video parameter sets, sequence parameter sets, picture parameter sets and supplemental enhance information in the HEVC standard. As each of the data slices SS₁ to SS_{K} may use a different parameter set to store and manage internal information, in step S240, the video reconstruction circuit 120 may first learn the parameter set that each of the data slices SS₁ to SS_{K} uses according to information in the headers of the data slices SS₁ to SS_{K}, and then retrieve the interested video data corresponding to the region of interest of each of the images from the data slices according to the information recorded in the parameter set obtained in step S230. FIG. 4 shows a detailed flowchart of step S240. For example but not limited to, step S240 may include sub-steps S242 to S246.

In step S242, the headers of the data slices SS₁ to SS_{K} are analyzed.

In step S244, the picture parameter sets corresponding to the data slices SS₁ to SS_{K} are obtained according to the respective headers of the data slices SS₁ to SS_{K} to obtain tile configuration parameters corresponding to the data slices SS₁ to SS_{K}.

In step S246, the interested video data corresponding to the region of interest ROI1 of the image IMG₁ is obtained according to the tile configuration parameters corresponding to the data slices SS₁ to SS_{K}.

In step S242 to step S246, the encoded data of the image IMG₁ to be reconstructed by the video reconstruction circuit 120 is taken as an example. At this point, in step S242, the video reconstruction circuit 120 may analyze the headers of the data slices SS₁ to SS_{K} of the image IMG₁. The header of a data slice records information including its corresponding parameter sets and encoding starting addresses of its video contents, and the corresponding parameter sets include tile parameters including sizes and numbers of tiles corresponding to the data slices SS₁ to SS_{K}. Thus, according to the headers of the data slices SS₁ to SS_{K} and the corresponding parameter sets, the video reconstruction circuit 120 may retrieve the interested video data corresponding to the region of interest ROI1 of the image IMG₁ from the data slices SS₁ to SS_{K}.

For example, the data slice SS₁ corresponds to tiles T1 to T7, with only the tile T7 locating in the region of interest ROI1 of the image IMG₁. That is to say, from the video data of the data slice SS₁ , only video data corresponding to the tile T7 is the interested video data associated with the region of interest ROI1 of the image IMG₁. Thus, in step S246, the video reconstruction circuit 120 may calculate a storage position of the video data corresponding to the tile T7 according to the header of the slicer SS₁ and the corresponding parameter sets to further retrieve the video data corresponding to the tile T7.

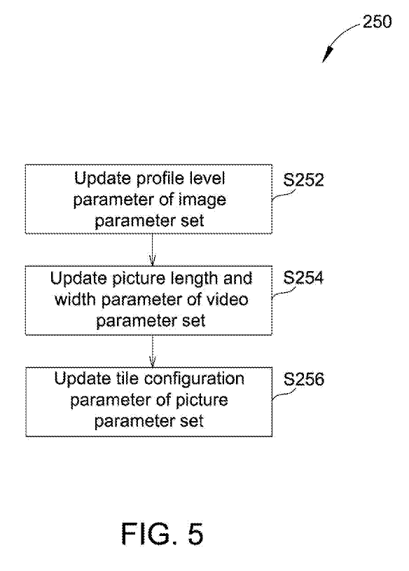

Sizes of images and numbers of tiles of the reconstructed video stream F1 may differ from those of the original video stream F0 that is to be reconstructed. Therefore, in addition to retrieving the interested video data required by the reconstructed video stream F1, to ensure that the interested video data in the reconstructed video stream F1 can be corrected analyzed, in step S250, the video parameter sets and the associated parameters in the picture parameter sets corresponding to the original data slices in the HEVC standard are updated to updated parameter sets. FIG. 5 shows a flowchart of step S250. For example but not limited to, step S250 includes sub-steps S252 to S256.

In step S252, profile level parameters of video parameter sets are updated.

In step S254, picture length and width parameters of the video parameter sets are updated.

In step S256, tile configuration parameters of the picture parameter sets are updated.

In step S252 to step S256, the video reconstruction circuit 120 updates the video parameter sets as well as the associated parameters in the video parameter sets and picture parameter sets to satisfy values corresponding to the reconstructed video stream F1. For example, the original picture length and width parameters may be adjusted to smaller values to match lengths and widths of the regions of interest of the images IMG₁ to IMG_{N}. In some embodiments of the present invention, the video reconstruction circuit 120 may update other parameters according to actual system requirements.

Similarly, in the embodiment above, the video reconstruction circuit 120 retrieves the video data corresponding to the region of interest ROI1 of the image IMG₁ from the data slice SS₁ , and deletes video data corresponding to outside the region of interest ROI1 of the image IMG₁ from the data slice SS₁. Thus, the header of the data slice SS₁ needs to be correspondingly updated as well. For example, from the header, the video reconstruction circuit 120 may need to update information including first_slice_segment_in_pic_flag that records whether the slice is a first slice segment in the picture, the corresponding slice_pic_parameter_set_id, the dependent_slice_segment_flag: dependent_slice_segment_flag that records whether a previous data slice is used, the slice_segment_address, the num_entry_point_offsets, offset_len_minus1, entry_point_offset_minus1[i], and data slice addresses.

After updating the header of the data slice SS₁ , the video reconstruction circuit 120 may combine the interested video data corresponding to the region of interest ROI1 of the image IMG₁ retrieved from the data slice SS₁ and the updated header to generate an updated data slice. Likewise, the video reconstruction circuit 120 may update the data slices SS₂ to SS_{K} using a similar method.

After obtaining the interested video data corresponding to the first region of interest ROI of each of the images IMG₁ to IMG_{N} through step S240, and updating the corresponding parameter sets through step S250, the video reconstruction circuit 120 has obtained video data to be displayed at the display end 130 and the parameter sets required for analyzing the video data. Thus, in step S260, the video reconstruction circuit 120 may integrate the interested video data and the updated parameter sets into the reconstructed video stream F1 conforming to the HEVC standard, so as to allow the display end 130 to display the video corresponding to the first region of interest ROI1 of each of the images IMG₁ to IMG_{N} according to the reconstructed video stream F1.

In another embodiment of the present invention, after obtaining the interested video data corresponding to the region of interest ROI1 of the image IMG₁, the video reconstruction circuit 120 may also again establish the required header according to system requirements to combine into a new data slice. For example, in practice, the decompression circuit 134 may determine whether a data slice corresponds to a last pixel of a tile according to a flag that records a tile end in the header of each data slice, so as to determine whether the decompression is completed. In this case, if the interested video data is purely retrieved from the original data slices SS₁ to SS_{K} without correspondingly correcting the flags, the decompression circuit 134 may not be able to verify the progress of the decompression and thus fail to complete the decompression. To solve this issue, after obtaining the interested video data from the data slices SS₁ to SS_{K} , the video reconstruction circuit 120 may again establish new data slices and the corresponding headers according to system requirements, update a part of the data slices that are not set with flags, or simultaneously establish new data slices and update a part of the data slices that are not set with flags, such that each new data slice and/or each updated data slice corresponds to a tile and sets the associated flag as the tile end.

That is to say, through again establishing new data slices and the corresponding headers and/or updating a part of the data slices and the headers, each new data slice and/or each updated data slice may correspond to a tile, and the associated flag is then set as the tile end. Thus, the decompression circuit 134 is allowed to successfully complete the decompression.

Further, the order for performing step S240 and step S250 is not limited; orders for performing step S240 and step S250 may be swapped or step S240 and step S250 may even be simultaneously performed.

Using the method 200, the video reconstruction circuit 120 may reconstruct the video stream F0 transmitted from the host end 110, and the video reconstruction system 110 is made capable of receiving video contents that originally cannot be decompressed as well as normally decompressing and displaying such video contents without modifying hardware equipments of the display end 130, thereby eliminating inconveniences caused by hardware matching of the prior art.

In FIG. 1, the video reconstruction system 100 may further include another display end 140. In addition to generating the reconstructed video stream F1 according to the video stream F0 that is to be reconstructed, the video reconstruction circuit 120 may generate another reconstructed video stream F2 for the display end 140 to decompress and display. In some embodiments of the present invention, display specifications of the display ends 130 and 140 may differ and may demand different regions of interest. For example, in FIG. 1, a region of interest ROI2 required by the display end 140 may be smaller than the region of interest ROI1 required by the display end 140. In this case, after step S230, the video reconstruction circuit 120 may retrieve the corresponding interested video data according to the region of interest ROI2 that the display end 140 requests to accordingly generate the video stream F2.

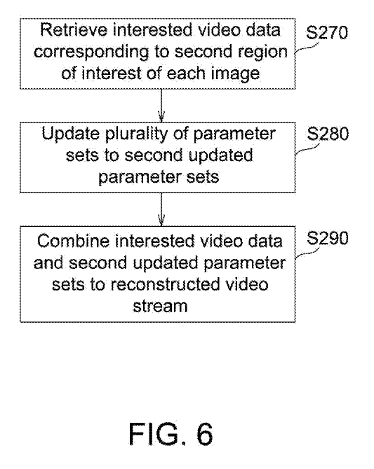

In other words, the method 200 may further include steps S270 to S290. FIG. 6 shows a flowchart of steps S270 to S290.

In step S270, interested video data corresponding to a second region of interest ROI2 of each of the images IMG₁ to IMG_{N} is retrieved from the data slices SS₁ to SS_{K} according to the parameter sets.

In step S280, the parameter sets are updated to a plurality of second parameter sets.

In step S290, the interested video data and the second updated parameter sets are combined into the reconstructed video stream F2.

Through a similar approach, the video reconstruction circuit 120 may support a greater number of display ends and provide corresponding reconstructed video streams. Further, steps S270 to S290 may be performed in parallel to steps S240 to S260, or be performed before or after steps S240 to S260.

In conclusion, with the method for reconstructing a video stream according to embodiments of the present invention, a user is allowed to receive video contents that originally cannot be decompressed and to normally decompress and display such video contents without modifying hardware equipments, thereby eliminating inconveniences caused by hardware matching of the prior art.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for reconstructing a video stream, a video stream that is to be reconstructed comprising encoded data of a plurality of images encoded by the High Efficiency Video Coding (HEVC) standard, each of the images comprising a plurality of tiles, the encoded data of each of the tiles comprising a plurality of data slices and a plurality of parameter sets, the method comprising:
receiving the video stream that is to be reconstructed;
analyzing the parameter sets in the video stream that is to be reconstructed;
retrieving a plurality of sets of interested video data corresponding to a region of interest of each of the images from the data slices according to the parameter sets;
updating the parameter sets to a plurality of updated parameter sets; and
generating a first reconstructed video stream according to at least the interest video data and the first updated parameter sets;
wherein, the tiles of each of the image blocks belong to a motion-constrained tile set (MCTS) defined by the HEVC standard.

2. The method according to claim 1, wherein the parameter sets comprise at least one video parameter set, at least one sequence parameter set, at least one picture parameter set and at least one set of supplemental enhance information.

3. The method according to claim 1, wherein the step of retrieving the interest video data corresponding to the first region of interest of each of the images from the data slices according to the parameter sets comprises:
analyzing a header of each of the data slices;
obtaining a picture parameter set corresponding to each of the data slices according to the header of each of the data slices to obtain a tile configuration parameter corresponding to each of the data slices; and
obtaining the interested video data according to the tile configuration parameter corresponding to each of the data slices.

4. The method according to claim 1, wherein the step of updating the parameter sets to the first updated parameter sets comprises:
updating a profile level parameter of a video parameter set;
updating a picture length and width parameter of a sequence parameter set; and
updating a tile configuration parameter of a picture parameter set.

5. The method according to claim 1, further comprising:
deleting at least one set of video data corresponding to outside the first region of interest from at least one of the data slices;
updating a header of the at least one data slice to at least one updated header; and
combining a plurality of sets of interested video data in the at least one data slice and the at least one updated header to generate at least one updated data slice.

6. The method according to claim 5, wherein the step of updating the header of the at least one data slice comprises updating a data starting address, an address offset and a data slice address in the header of the at least one data slice.

7. The method according to claim 1, further comprising establishing at least one new data slice and a header of the at least one new data slice according to a part of the interest video data.

8. The method according to claim 1, further comprising:
deleting at least one set of interested video data corresponding to outside the first region of interest from at least one of the data slices;
updating a header of the at least one data slice;
combining a plurality of sets of interested video data in the at least one data slice and the at least one updated header to generate at least one updated data slice; and
establishing at least one new data slice and a header of the at least one new data slice according to a part of the interested video data;
wherein, each of the at least one updated data slice and the at least one new data slice corresponds to a tile.

9. The method according to claim 1, further comprising:
retrieving a plurality of sets of interested video data corresponding to a second region of interest of each of the images from the data slices according to the parameter sets;
updating the parameter sets to a plurality of second updated parameter sets; and
combining the interested video data and the updated second parameter sets to a second reconstructed video stream.

10. The method according to claim 1, further comprising:
adjusting a position of a region of interest of each of the images according to a motion of a critical object in the images dynamically or according to a predetermined condition.
